(19) United States
(12) Patent Application Publication
(10) Pub. No.: US 2004/0001510 A1
(43) Pub. Date: Jan. 1, 2004

(54) Method and system for processing communications data

(76) Inventor: Anthony G. Hamilton, Durham, NC (US)

Correspondence Address: John P. Ward, Blakely, Sokoloff, Taylor & Zafman LLP, Seventh Floor, 12400 Wilshire Boulevard, Los Angeles, CA, 90025-1030, US

(21) Appl. No.: 10/187,650

(22) Filed: Jul. 1, 2002

(51) Int. Cl. H04L 12/56

(52) U.S. Cl. 370/466

(57) ABSTRACT

A method and device are provided to receive a communications data stream in a system; to determine a service class to which the communications data steam relates; to determine a configuration for the system to process the communications data stream based on its service class; to change a configuration for the system to the determined configuration and to process the communications data stream while the system is in the determined configuration.

### FIELD OF THE INVENTION

Embodiments of the invention relate to data processing in general, and to the processing of communications data in mobile computing devices, in particular.

### BACKGROUND

Today, mobile computing devices or systems such as notebook computers, Personal Digital Assistants (PDAs), Personal Information Managers (PIMs), etc. are able to wirelessly connect to remote networks, for example the Internet, and to upload or download information to or from such remote networks. Data typically uploaded or downloaded may include email messages, streaming audio or video, etc. and will hereinafter be referred to as “communications data”.

Certain types of communications data may by its very nature require to be processed immediately, while the processing of other types of communications data may be deferred. For example, communications data relating to a video conference call will need to be processed immediately, whereas electronic mail messages that are not indicated as being urgent may be processed later.

Further, communications data are not all equal in their consumption of system resources used in order to process the data. For example, communications data containing images will require more system resources to process than say communications data consisting only of text.

Mobile computing devices or systems that process all communications data equally regardless of its priority could give rise to problems. For example, communications data relating to a video conference call, may be deferred for later processing, or a system may process video data which consumes a large amount of system resources, while the system is running on battery power. In these examples, the data relating to the video conference call should be processed immediately, whereas processing the video data should be deferred to when the system is on a.c. power thereby to conserve battery power.

### BRIEF DESCRIPTION OF THE DRAWINGS

FIG. 1 shows a flowchart of operations performed when processing communications data in accordance with one embodiment of the invention;

FIG. 2 shows a flowchart of operations performed when processing communications data in accordance with another embodiment of the invention;

FIG. 3 shows a flowchart of operations performed when processing communications data in accordance with yet a further embodiment of the invention; and

FIG. 4 shows a high level block diagram of a system for processing communications data in accordance with embodiments of the invention.

### DETAILED DESCRIPTION

Embodiments of the invention disclose a method and apparatus for processing communications data. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

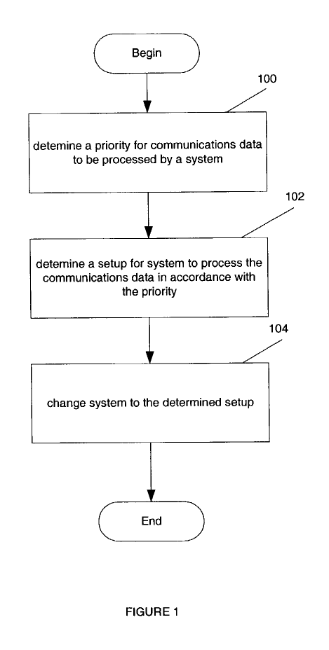

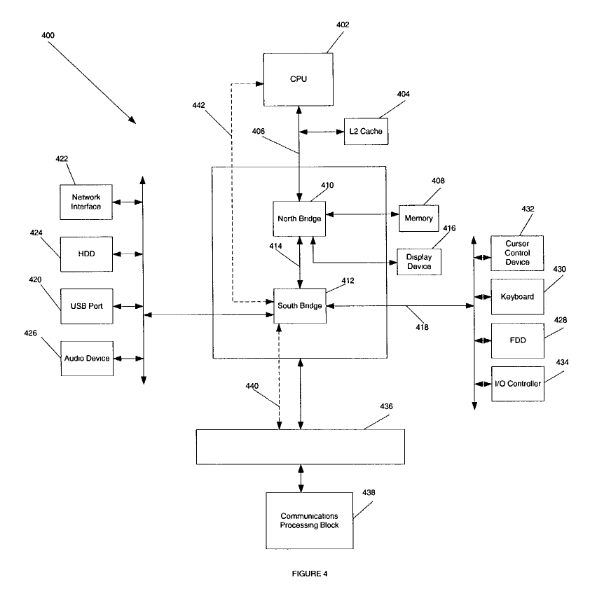

FIG. 1 of the drawings shows a flow chart of operations performed when processing communications data in accordance with one embodiment of the invention. Referring to FIG. 1, at block 100 a system 400, which described below with reference to FIG. 4, and which in embodiments of the invention may be a mobile computing system such as a notebook computer or a Personal Digital Assistant (PDA), determines a priority for communications data to be processed by system 400. In one embodiment, determining the priority is based on a service class hierarchy wherein communications data relating to various services is assigned a predetermined priority based on the nature of the service to which the communications data relates. For example, the communications data may relate to an email message, a video message, an audio message, or a paging message.

In one embodiment, a user assigns a priority for communications data from each service class. In another embodiment, in which the communications data is being sent by a third party service provider, the service provider provides identifiers together with the communications data which identifies a priority of the data. In this embodiment, determining the priority for the communications data includes reading the identifier included with the communications data.

Once the priority for the data determined, at block 102 the system 400 determines a setup to process the communications data in accordance with the priority. For example, at block 100 it might have been determined that the incoming data relates to a video conference call in which case at 102 the system 400 determines an optimal setup to process the data relating to the video conference call.

In one embodiment, determining the setup includes determining how the task of processing the communication data gets divided between various functional blocks of system 400. In a further embodiment, determining the setup includes determining which processing or functional blocks should be involved in processing the or aspects of the communications data. This is described in greater detail with reference to FIG. 4. In another embodiment, determining the setup for system 400 may include determining the speed at which a processor for system 400 operates, or the speed at which a peripheral bus configured to serve a communications processing block operates. In one embodiment, the peripheral bus is a third or fourth generation peripheral bus which is fully scalable. In this embodiment, determining the setup includes determining a number of communications paths or links within the peripheral bus to enable in order to optimally process the data.

Once the setup for system 400 has been determined, at block 104 a setup of the system is changed to the determined setup. In some embodiments, there is a temporal aspect that specifies when the change should occur. For example, in one embodiment of the invention, the system 400 may be running on battery power and the communications data may relate to non-urgent video data. In this case, the change would occur when the system is back on a.c. power. This allows for the conservation of system resources e.g. battery power. After the change, the communications data is processed by system 400 while in the determined setup.

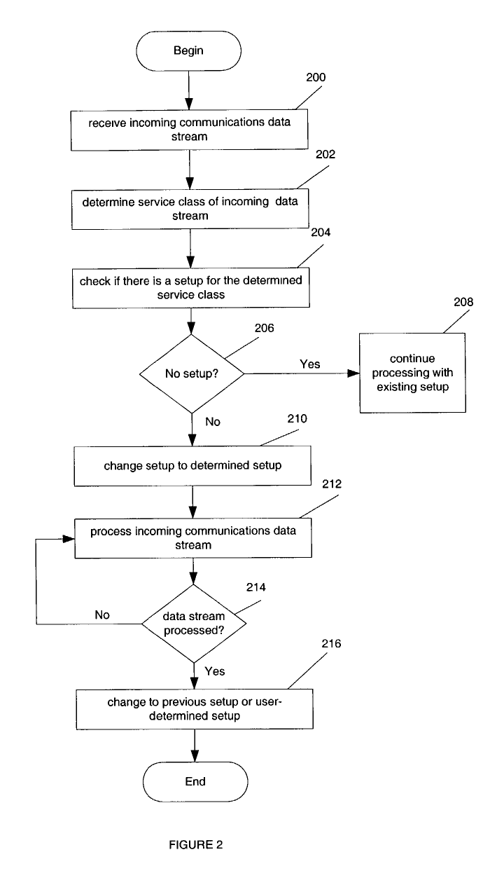

Referring now to FIG. 2 of the drawings, a flowchart of operations performed by system 400 when processing communications data in accordance with another embodiment of the invention is shown. Starting at block 200, system 400 receives an incoming communications data stream. At block 202, system 400 determines the service class for the incoming data stream. This is done by reading a service class identifier included or embedded in the incoming communication data stream. In one embodiment, the service class identifier identifies the data as being data that relates to an email message, a paging message, video, or audio data.

At block 204 system 400 checks if there is a setup for the determined service class. At 206, if no setup is found, processing branches to block 208 wherein the incoming communications data stream is processed in accordance with an existing setup for system 400. If, it is determined that there is a setup for the determined service class, then block 210 executes, wherein a setup for system 400 is changed to the determined setup.

At block 212, system 400 processes the incoming communications data stream while in the determined setup. At block 214, system 400 checks if the incoming communication data stream has been completely processed. If the incoming communications data stream has not been completely processed, then execution of block 212 continues, otherwise block 216 executes, wherein a setup for system 400 is changed to the previous setup or a user determined setup.

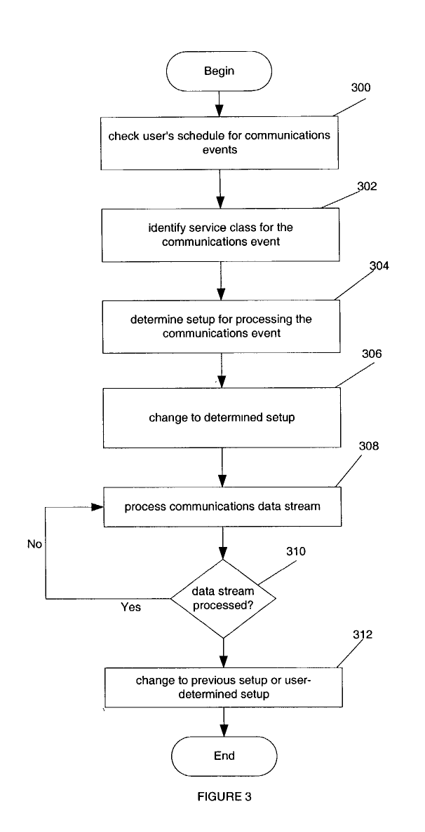

FIG. 3 of the drawings shows a flowchart of operations performed by system 400 in accordance with yet another embodiment of the invention. Referring to FIG. 3, at block 300 system 400 checks a user's schedule for a communications event. The user's schedule may be a custom software application, or it may be a commercially available scheduling program such as Microsoft Outlook or Lotus Notes. As used herein, the term “communications event” relates to an event that require the processing of communications data including the sending and receiving of such data. For example, the communications event may be a video conference call scheduled to occur at some future time. In one embodiment, since communications data relating to a particular communications event, may involve the sending and receiving of large amounts of data, a user of system 400 books a time slot with a service provider, during which time the service provider would send communications data to the system at a higher rate or bandwidth. This reduces the time spent downloading the data from the communications event.

Block 302 system 400 identifies a service class for the communications event. At block 304, system 400 determines a setup for processing the communications event. At block 306, system 400 changes to the determined setup. At block 308 the communications data is processed while system 400 is in the determined setup. At 310, system 400 determines if the processing at 308 has ended. If the processing has not ended, then block 308 continues to execute. If the processing has ended, then the block 312 executes, wherein a setup of system 400 is changed to a previous setup or a user-determined setup.

Referring now to FIG. 4 of the drawings, a high level block diagram showing components of a system 400 for processing communications data in accordance with one embodiment of the invention is illustrated. System 400 includes a processing device, such as a central processing unit (CPU) 402, which is connected to a level 2 (L2) cache 404 via a processor bus (PSB) 406. PSB 406 is in turn coupled to a memory 408 via a north bridge circuit 410. The north bridge circuit 410 is connected to a south bridge circuit 412 via an expansion bus such as local bus 414, which may include a Peripheral Component Interconnect (PCI) bus, video electronics standard association (VESA) bus, or the like. North bridge circuit 410 provides high speed access to selected devices such as a display device 416.

Memory 408 may include read-only (ROM) and/or random access (RAM) memory devices such as a synchronous dynamic random access memory (SDRAM) module capable of storing data as well as instructions to be executed by CPU 402. Access to data instructions stored within memory 408 is provided via a memory controller (not shown) within north bridge circuit 410. L2 cache 404 is similarly used, typically in a hierarchy manner, to store data and instructions for direct access by CPU 402. Display device 416 may include a liquid crystal display (LCD) or other similar device for displaying various kinds of data for a computer user.

The system 400 further includes an expansion bus 418 such as the Industry Standard Architecture (ISA) bus which is coupled to south bridge circuit 412. South bridge circuit 412 includes a universal serial bus (USB) port 420, as well as other direct connections for devices such as a network interface card 422, a storage device 424, such as magnetic hard disk drive, and an audio device 426 such as a speaker or sound card.

Other devices not directly coupled to south bridge 412 may be connected to system 400 via the expansion bus 418 as illustrated. A floppy disk drive (FDD) 428 providing additional storage capacity on removable media storage devices such as a disk, and input devices such as a keyboard 430 and a cursor control device 432 are each coupled to expansion bus 418 to communicate data, instructions, and/or command selections to CPU 402. Cursor control device 432 may comprise a conventional mouse, a track ball, or any other device capable of conveying the right cursor manipulation. Similarly, expansion bus 418 includes an input/output (I/O) controller 434 having standard serial and parallel port functionality for connecting other I/O devices such as a printer to system 400.

The system further includes a peripheral bus 436 which is coupled to south bridge circuit 412 and to a communications processing block 438. CPU 402 includes an operating system and program memory (not shown) storing instructions which when executed perform the methods of processing communications data as described above.

In one embodiment, communications processing block 438 receives incoming communications data and determines a service class for the data based on service class identifiers contained in the data in accordance with the methods described. The communications processing block 436 via a side band signal 440 including information on the service class to south bridge circuit 412. South bridge circuit 412 includes an arbitration engine (not shown), which sends a side band signal 442 to CPU 402, notifying the CPU of the service class of the incoming communications data. In accordance with the methods described above, CPU determines the priority for the incoming communications data, a setup for system 400 based on the priority and changes a system configuration for system 400 to the determined setup. System 400 then processes the incoming communications data stream using the determined setup. For example, if the incoming communications data stream relates to video conferencing data, the speed of operation for CPU 402 will be scaled up, the frequency of bus 406 will be scaled up, the frequency of operation of peripheral bus 426 will be scaled up, and further, a number of communications paths or links within peripheral bus 426 would be increased in order to facilitate processing of incoming communications data stream. In one embodiment, determining the setup includes determining the functional blocks responsible for processing the or aspects of the communications data. For example, the determined setup in some embodiments specifies which processing steps are to be performed by CPU 402 and/or communications processing block 438.

It will be apparent from this description the aspects of the present invention may be embodied, at least partly, in software. In other embodiments, hardware circuitry may be used in combination with software instructions to implement the present invention. Thus, the embodiments of the invention are not limited to any specific combination of hardware circuitry and software.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method comprising:
receiving a communications data stream in a system;
determining a service class to which the communications data stream relates;
determining a configuration for the system to process the communications data stream based on its service class;
changing a configuration for the system to the determined configuration; and
processing the communications data stream while the system is in the determined configuration.

2. The method of claim 1, wherein determining the service class comprises reading service class identifiers in the communication data stream.

3. The method of claim 2, wherein the service class identifiers identify the communications data based on a service class selected from the group consisting of electronic mail, paging, voice, and video services.

4. The method of claim 1, further comprising predetermining a configuration for the system to process communications data from each service class.

5. The method of claim 4, wherein determining the configuration comprises selecting the predetermined configuration for the determined service class.

6. The method of claim 1, further comprising changing the configuration for the system to its setup before the change, after processing the communications data.

7. The method of claim 1, further comprising changing the configuration for the system to a user-determined configuration, after processing the communications data.

8. A method comprising:
checking a schedule for a next-scheduled communications event requiring a processing of communications data by a system;
identifying a service class for the communications data;
determining a configuration for the system to process the communications data;
changing the system to the determined configuration; and
processing the communications data in accordance with the schedule, while the system is in the determined configuration.

9. The method of claim 8, wherein identifying the service class is based on a service class identifier selected from the group consisting of electronic mail, paging, voice, and video services.

10. Apparatus comprising:
a processing system; and
a memory coupled to the processing system, the memory storing instructions which when executed by the processing system cause the processing system to perform a method comprising:
receiving a communications data stream;
determining a service class to which the communications data stream relates;
determining a configuration for the apparatus to process the communications data stream based on its service class;
changing a configuration for the apparatus to the determined configuration; and
processing the communications data stream while the apparatus is in the determined configuration.

11. The apparatus of claim 10, wherein determining the service class comprises reading service class identifiers in the communications data stream.

12. The apparatus of claim 11, wherein the service class identifiers identify the communications data based on a service class selected from the group consisting of electronic mail, paging, voice, and video services.

13. The apparatus of claim 12, wherein the method further comprises predetermining a configuration for the apparatus to process communications data from each service class.

14. The apparatus of claim 13, wherein determining the configuration comprises selecting the predetermined configuration for the determined service class.

15. The apparatus of claim 10, wherein the method further comprises changing the configuration for the apparatus to its configuration before the change, after processing the communications data.

16. The apparatus of claim 10, wherein the method further comprises changing the configuration for the apparatus to a user-determined configuration, after processing the communications data.

17. Apparatus comprising:
a processing system; and
a memory coupled to the processing system, the memory storing instructions which when executed by the processing system cause the processing system to perform a method comprising:
checking a schedule for a next-scheduled communications event requiring processing of communications data by the apparatus;
identifying a service class for the communications data;
determining a configuration for the apparatus to process the communications data;
changing the apparatus to the determined configuration; and
processing the communications data in accordance with the schedule while the apparatus is in the determined.

18. The apparatus of claim 17, wherein identifying the service class is based on a service identifier selected from a group consisting of a electronic mail, paging, voice, and video services.

19. A computer-readable medium storing instructions which when executed by a processing system cause the system to perform a method comprising:
receiving a communications data stream;
determining a service class to which the communications data stream relates;
determining a configuration for the processing system to process the communications data stream based on its service class;
changing a setup for the processing system to the determined configuration; and
processing the communications data stream while the processing system is in the determined configuration.

20. The computer-readable medium of claim 19, wherein determining the service class comprises reading service class identifiers in the communications data stream.

21. The computer-readable medium of claim 20, wherein the service class identifiers identify the communications data based on a service class selected from the group consisting of electronic mail, paging, voice, and video services.

22. A computer-readable medium storing a sequence of instructions which when executed by a processing system cause the processing system to perform a method comprising:
checking a schedule for a next-scheduled communications event requiring the processing of communications data by the processing system;
identifying the service class for the communications data;
determining a configuration for the processing system to process the communications data;
changing the processing system to the determined configuration; and
processing the communications data in accordance with the schedule while the processing system is in the determined configuration.

23. The computer-readable medium of claim 22, wherein identifying the service class is based on a service identifier selected from a group consisting of a electronic mail, paging, voice, and video services.

24. A system comprising:
a central processing unit;
a chipset including a north bridge circuit and a south bridge circuit, the chipset being coupled to the central processing unit;
a communications processing block coupled to the chipset, to receive a communications data stream, to determine a service class to which the communications data stream relate; and to send the service class to the south bridge circuit via a sidebands signal;
wherein the central processing unit determines a configuration for the system to process the incoming communications data stream based on the service class; and changes the system to the determined configuration.

25. The system of claim 24, wherein the communications processing block is coupled to the chipset by a peripheral bus which is scalable.

26. The system of claim 25, wherein changing the configuration of the system to the determined configuration comprises changing a number of communications data paths in the peripheral bus.

27. The system of claim 26, wherein changing the configuration of the system to the determined configuration comprises changing a frequency of operation of the peripheral bus.

28. The system of claim 27, wherein changing the configuration of the system to the determined configuration, comprises selecting functional blocks of the system to process the or aspects of the incoming communications data stream.

29. The system of claim 28, wherein changing the configuration of the system to the determined configuration comprises changing a speed of operation of the central processing unit.
